(19) United States
(12) Patent Application Publication
(10) Pub. No.: US 2017/0269206 A1
(43) Pub. Date: Sep. 21, 2017

(54) RADAR APPARATUS, OBSERVING METHOD AND NON-TRANSITORY COMPUTER READABLE MEDIUM

(71) Applicant: KABUSHIKI KAISHA TOSHIBA, Tokyo (JP)

(72) Inventors: Tomomi AOKI, Yokohama (JP); Kazuaki KAWABATA, Yokohama (JP); Koichiro GOMI, Yokohama (JP); Shigeru HIURA, Tokyo (JP)

(73) Assignee: Kabushiki Kaisha Toshiba

(21) Appl. No.: 15/394,071

(22) Filed: Dec. 29, 2016

(30) Foreign Application Priority Data
Mar. 15, 2016 (JP) 2016-051589

(51) Int. Cl. G01S 13/95; G01S 7/292

(52) U.S. Cl. CPC G01S 13/95; G01S 7/292

(57) ABSTRACT

A radar apparatus according to an embodiment of the present invention includes an oversampler, a weight vector calculator, a meteorological parameter calculator, an error influence degree calculator, and an error reducer. The oversampler performs oversampling on a received signal to acquire a sampling signal. The weight vector calculator calculates a weight vector based on the sampling signal and a waveform information matrix. The meteorological parameter calculator calculates an estimated value of a meteorological parameter on an observation target based on the vector and the matrix. The error influence degree calculator selects a first observation target considering an estimated error included in the estimated value, or an error influence degree based on the estimated error. The error reducer subtracts an estimated error that the first observation target gives to an estimated value of a meteorological parameter on a second observation target, from the estimated value on the second observation target.

### CROSS-REFERENCE TO RELATED APPLICATION (S)

This application is based upon and claims the benefit of priority from Japanese Patent Application No. 2016-051589, filed Mar. 15, 2016; the entire contents of which are incorporated herein by reference.

### FIELD

Embodiments described herein relate generally to a radar apparatus, an observing method and non-transitory computer readable medium.

### BACKGROUND

In order to accurately observe or predict a meteorological phenomenon such as a rain cloud that develops rapidly and locally, causing extensive damage, a high-resolution meteorological radar apparatus is needed. The resolution is basically determined from an antenna diameter, a pulse width, and the like. Therefore, for the enhancement of the resolution, measure is performed such as increasing the antenna diameter of the meteorological radar apparatus to reduce the width of a beam to be transmitted, and reducing the pulse width of a transmission pulse. However, these measures raise problems such as an increase in the size of antenna equipment, an increase in the cost of the equipment, and a decrease in received power.

For such problems, in the viewpoint of signal processing, efforts to enhance a resolution have been made. For example, oversampling which can enhance a resolution by sampling at a rate higher than normal sampling rate is performed.

However, due to perform the oversampling, signals from observation targets other than a desired observation target leaks into a signal of the desired observation target. This causes an estimated error to be included in an estimated value calculated based on a sampling signal. The estimated error can be eliminated by inverse matrix operation or the like. However, with an increase in the number of oversamples, this raises such a problem that the computational complexity of the inverse matrix operation increases or the result of the inverse matrix operation becomes unstable.

### BRIEF DESCRIPTION OF THE DRAWINGS

FIG. 1 is a block diagram illustrating an example of a schematic configuration of a radar apparatus according to a first embodiment;

FIG. 2 is a diagram for illustrating temporal oversampling;

FIG. 3A to FIG. 3D are diagrams for illustrating the performance of the present embodiment;

FIG. 4 is the flowchart of a process performed on a received signal by the radar apparatus according to the present embodiment;

FIG. 5 is a block diagram illustrating an example of a schematic configuration of a radar apparatus according to a second embodiment;

FIG. 6 is a diagram for illustrating spatial oversampling; and

FIG. 7 is a block diagram illustrating an example of a hardware configuration that implements the radar apparatus according to an embodiment of the present invention.

### DETAILED DESCRIPTION

A radar apparatus according to an embodiment of the present invention includes an oversampler, a weight vector calculator, a meteorological parameter calculator, an error influence degree calculator, and an error reducer.

The oversampler performs oversampling on a received signal to acquire a sampling signal.

The weight vector calculator calculates a weight vector based on the sampling signal and a waveform information matrix.

The meteorological parameter calculator calculates an estimated value of a meteorological parameter on an observation target based on the weight vector and the waveform information matrix.

The error influence degree calculator selects a first observation target considering an estimated error included in the estimated value of the meteorological parameter, or an error influence degree based on the estimated error.

The error reducer subtracts an estimated error that the first observation target gives to an estimated value of a meteorological parameter on a second observation target, from the estimated value of the meteorological parameter on the second observation target.

The embodiment of the present invention provides a meteorological radar apparatus that reduces an estimated error occurring in oversampling.

Below, a description is given of embodiments of the present invention with reference to the drawings. The present invention is not limited to the embodiments.

### First Embodiment

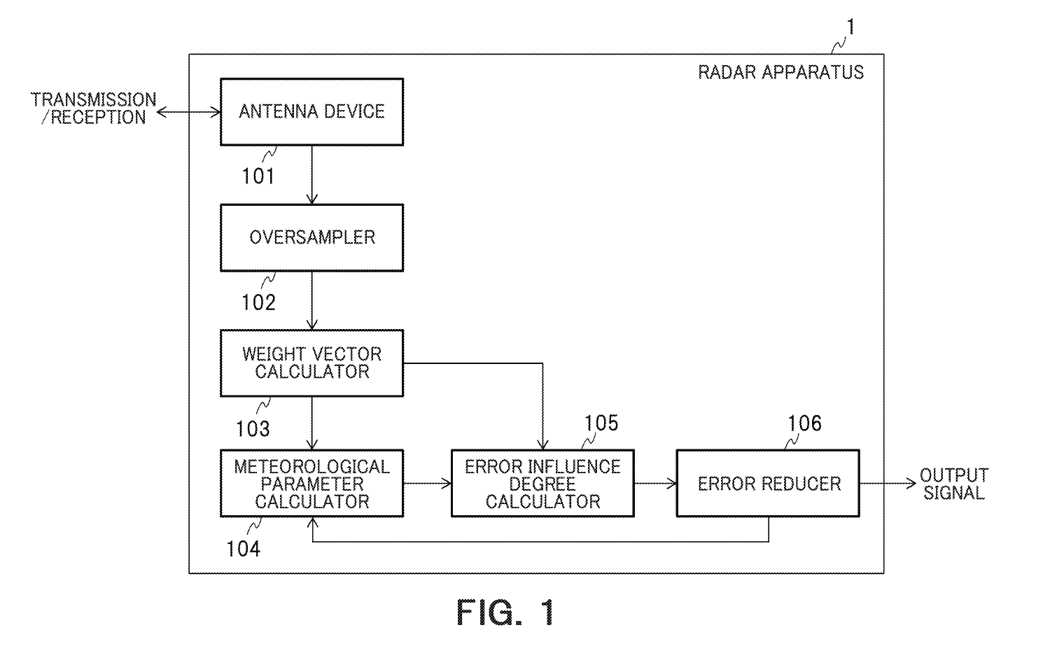

FIG. 1 is a block diagram illustrating an example of a schematic configuration of a radar apparatus according to a first embodiment.

A radar apparatus 1 according to the present embodiment includes an antenna device 101, an oversampler 102, a weight vector calculator 103, a meteorological parameter calculator 104, an error influence degree calculator 105, and an error reducer 106.

The radar apparatus 1 according to the first embodiment emits a transmission beam (transmission signal) toward an observation target and observes the observation target based on a radio wave reflected from the target (a reflected wave). In addition, the radar apparatus 1 enhances the resolution thereof by oversampling a received signal included in the reflected wave. Furthermore, the radar apparatus 1 performs a process to reduce an estimated error occurring in the oversampling, which will be described in detail together with the internal configuration of the radar apparatus 1.

Note that the direction of the transmission beam emitted from the radar apparatus 1 toward the observation target will be referred to as a range direction. In addition, the horizontal direction with respect to the range direction will be referred to as a cell direction. Furthermore, the resolution in the range direction will be referred to as a range resolution, and the resolution in the cell direction will be referred to as a cell resolution.

Components of the radar apparatus 1 will be described below.

The antenna device 101 emits a transmission signal (transmission pulse) toward an observation target and receives a reflected wave that is reflected on the observation target. In addition, the antenna device 101 extracts a signal from the observation target (a received signal) from the reflected wave. As the antenna device 101, a well-known antenna device capable of performing these processes may be used.

The oversampler 102 performs oversampling on the received signal to enhance a resolution. In the present embodiment, it is assumed that the oversampling is performed in a temporal manner so as to enhance the range resolution. In the oversampling in a temporal manner, sampling is performed at time intervals shorter than the pulse width of the transmission signal that is the origin of the received signal. This enables to get more signals than those obtained by normal sampling.

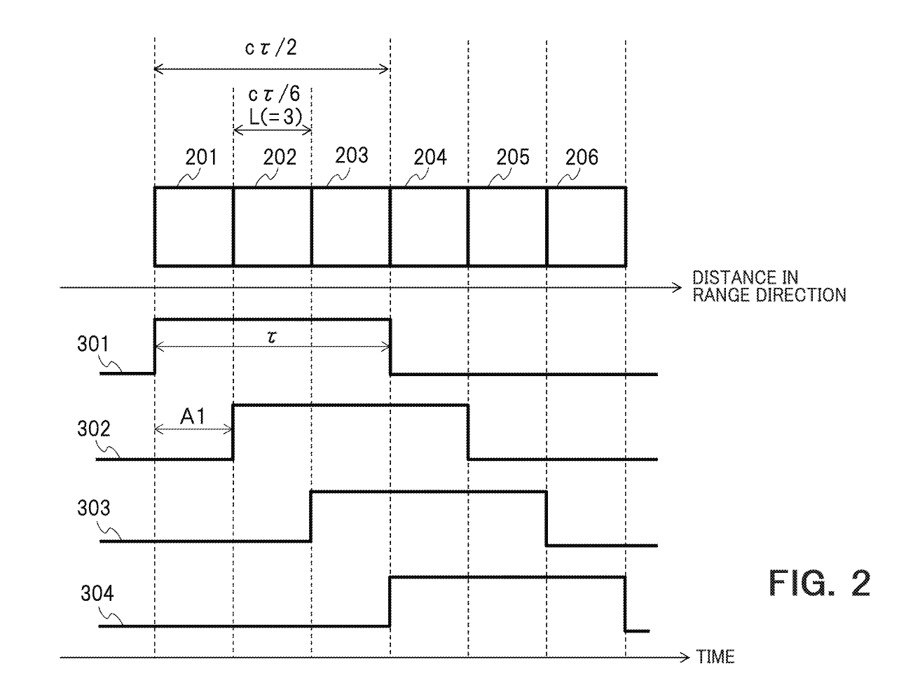

FIG. 2 is a diagram for illustrating the oversampling performed in a temporal manner. Rectangles illustrated in the upper part of FIG. 2 represent observation targets 201 to 206. The observation targets are assumed to be distributed in the range direction.

Waveforms in FIG. 2 represent sampling timings 301 to 304. The sampling timings 301 to 304 are sampling timings of ideal rectangular waves with a pulse width τ. When the oversampling is not performed, a signal is sampled at intervals of the pulse width τ, and thus sampling timings to be used are the sampling timing 301 and 304.

With each sampling timing, a signal from a width (distance) of cτ/2 in the range direction is acquired, where c represents the speed of light. Here, cτ/2 in FIG. 2 is assumed to be three times the width of each observation target. As illustrated in FIG. 2, three observation targets are included within the width of cτ/2. That is, when the oversampling is not performed, signals of the observation targets 201 to 203 are collectively acquired with the sampling timing 301, and signals of the observation targets 204 to 206 are collectively acquired with the sampling timing 304. Hence, the signals of the individual observation targets cannot be distinguished from one another. That is, the resolution in not performing the oversampling can be said to be three times smaller than a desired resolution.

In contrast, when the oversampling is performed, sampling is performed in each oversampling time period A1. FIG. 2 illustrates sampling timings in the case where the oversampling is performed with all of the sampling timings 301 to 304. In FIG. 2, since three observation targets are included in the width of cτ/2, and thus setting the oversampling time period A1 at τ/3 makes a shift in distance between adjacent sampling timings cτ/6. Consequently, from signals acquired with the sampling timings 301, 302, and 303, the signals of the individual observation targets 201, 202, and 203 can be distinguished from one another. Thus, increasing sampling timings enables the signals of individual observation targets to be distinguished from one another.

Note that the oversampling time period A1 is expressed as A1=τ/L, where L represents an oversampling coefficient. The oversampling coefficient “L” is expressed in the form of the ratio of the desired resolution to the resolution in not performing the oversampling. In FIG. 2, the oversampling coefficient “L” is 3.

The oversampler 102 performs the oversampling based on the oversampling coefficient L or the oversampling time period A1. The oversampling coefficient L or the oversampling time period A1 may be determined in the oversampler 102 in advance or may be specified via an input device (not illustrated) or the like by a user or another apparatus. Alternatively, it may suffice that the user or the other apparatus specifies the width in the range direction and the oversampler 102 calculates the oversampling coefficient L and the oversampling time period A1 based on the specified width in the range direction and the pulse width “τ”. The pulse width “τ” may be determined in the oversampler 102 in advance or may be acquired from the antenna device 101.

However, performing the oversampling will get signals L times more as compared with not performing the oversampling.

In the example illustrated in FIG. 2, the relation between a sampling signal acquired through the oversampling and the signal of an observation target is expressed as the following expression using a determinant.

$$\begin{matrix}[ Expression 1 ] & \\ V = QS \\ [ \begin{matrix}{V}_{1} \\ {V}_{2} \\ {V}_{3}\end{matrix} ] = [ \begin{matrix}1 & 1 & 1 & 0 & 0 \\ 0 & 1 & 1 & 1 & 0 \\ 0 & 0 & 1 & 1 & 1\end{matrix} ] [ \begin{matrix}{S}_{1} \\ {S}_{2} \\ {S}_{3} \\ {S}_{4} \\ {S}_{5}\end{matrix} ] & ( 1 )\end{matrix}$$

A sign “V” in Expression (1) represents the sampling signal vector. Signs “V₁” to “V₃”, the elements of the sampling signal vector “V”, represent signals acquired with the sampling timings 301 to 303, respectively.

A sign “S” in Expression (1) represents the signal vector of each of observation targets acquired with the sampling timings 301 to 303. Signs “S₁” to “S₅”, the elements of the signal vector “S” of an observation target, represent the signals of the observation targets 201 to 205, respectively. Here, the signal of an observation target will be referred to as a meteorological parameter.

Examples of the meteorological parameter include received power, Doppler velocity, and the like, and the meteorological parameter may be determined in anything observable by the radar. For example, in the case of using a dual-polarization radar, the meteorological parameter may be the difference in signal power, phase difference, or the like between polarized waves.

For example, assuming that the meteorological parameter represents received power, it is possible to calculate rainfall in an observation target. Alternatively, assuming that the meteorological parameter represents Doppler velocity, it is possible to calculate the moving speed and direction of a cloud, that is, the velocity and direction of wind. The above will be described in detail together with the meteorological parameter calculator 104.

A matrix that is multiplied to the meteorological parameter “S” is referred to as a waveform information matrix “Q”. The value of the waveform information matrix “Q” is derived based on the range of a signal acquired with each sampling timing. The range of the signal acquired with each sampling timing is determined according to a transmission pulse waveform and a filter coefficient. For example, with the sampling timing 301 in FIG. 2, the signals of the observation targets 201 to 203 are acquired, that is, the composite signals of the meteorological parameters “S₁” to “S₃” are acquired. Consequently, as expressed in Expression (1), the value of the first row of the waveform information matrix “Q” is {11100}. In such a manner, each value of the waveform information matrix “Q” is determined.

Based on the sampling signal vector “V” and the waveform information matrix “Q”, the weight vector calculator 103 calculates a weight vector “Ω”. The weight vector “Ω” is to be multiplied to the sampling signal V to calculate the meteorological parameter.

As a method for calculating the weight vector “Ω”, a well-known calculation technique may be used. Examples of the method include such as the Capon method, the Fourier method, and a method based on the minimum mean square error (MMSE), and any of them may be used. For example, assuming that the Capon method is used, a weight vector “ωⱼ” for the j-th observation target, an element of the weight vector “Ω”, is expressed by the following expression.

$$\begin{matrix}[ Expression 2 ] & \\ {ω}_{j} = \frac{{R}^{- 1} {q}_{j}}{{q}_{j}^{H} {R}^{- 1} {q}_{j}} & ( 2 )\end{matrix}$$

A sign “R” is the correlation matrix of the sampling signal vector “V”. A sign “R⁻¹” means the inverse matrix of “R”. A sign “qⱼ” represents the vector of the j-th column in the waveform information matrix “Q”. A sign “qⱼ^{H}” represents the complex conjugation of “qⱼ”.

The meteorological parameter calculator 104 calculates an estimated value of the meteorological parameter on an observation target based on the weight vector “Ω” and the waveform information matrix “Q”, using a meteorological parameter estimating expression.

For example, a method for calculating an estimated value of the meteorological parameter will be described assuming that the meteorological parameter represents signal power. Note that the description will be made using ̂ (hat) as a symbol representing an estimated value. In addition, a sign attached with ̂ (hat) will be referred to as a hat sign. For example, an estimated value of the signal power of the j-th observation target is denoted by a “hat Pⱼ”. The “hat Pⱼ” can be calculated by the following meteorological parameter estimating expression.

$$\begin{matrix}[ Expression 3 ] & \\ \begin{matrix}{\hat{P}}_{j} = {\sum }_{n = 1}^{N} {E}_{jn} {P}_{n} \\ = {\sum }_{n = 1}^{N} {( {Q}^{H} {ω}_{j} )}_{n}^{2} {P}_{n}\end{matrix} & ( 3 )\end{matrix}$$

A sign “Pₙ” represents a true signal power (the true value of a signal power) of an n-th observation target. A sign “Eⱼₙ” represents an n-th element of a matrix that is the square of the product of a conjugate transpose “Q^{H}” of the waveform information matrix Q and the weight vector “ωⱼ” of the j-th observation target. A sign “N” represents the number of observation targets observable through the oversampling, being represented as N=2L−1 using the oversampling coefficient “L”.

The meteorological parameter calculator 104 substitutes a provisional true value into “Pₙ” to calculate the estimated value. The provisional true value may be a predetermined value or may be calculated based on the sampling signal vector “V”. As will be described later, the meteorological parameter calculator 104 substitutes an estimated value of a new meteorological parameter passed from the error reducer 106 into “Pₙ” in the above Expression to obtain a new “hat Pⱼ”.

In addition, as another example, a method for calculating an estimated value of the meteorological parameter will be described assuming that the meteorological parameter represents Doppler velocity. When an estimated value of the Doppler velocity of the j-th observation target is denoted by a “hat vⱼ”, the “hat vⱼ” can be calculated by the following meteorological parameter estimating expression.

$$\begin{matrix}[ Expression 4 ] & \\ {\hat{v}}_{j} = - \frac{λ}{4 π {T}_{s}} arg ( {R}_{tj} {T}_{s} ) & ( 4 )\end{matrix}$$

A sign “λ” represents the wavelength of a transmission pulse, sign “Tₛ” represents a pulse repetition interval (PRI), and a sign “Rₜⱼ” represents a correlation coefficient between sampling signals.

An “arg(RₜⱼTₛ)” in Expression (4) can be calculated by the following expression.

$$\begin{matrix}[ Expression 5 ] & \\ arg ( {R}_{tj} {T}_{s} ) = atan \frac{{\sum }_{n = 1}^{N} {E}_{jn} {P}_{n} sin {φ}_{n}}{{\sum }_{n = 1}^{N} {E}_{jn} {P}_{n} cos {φ}_{n}} & ( 5 )\end{matrix}$$

A “a tan” represents the inverse trigonometric function of tangent. In addition, sign “φₙ” is expressed by φₙ=−4πvₙTₛ/λ. A sign “vₙ” in the calculation expression of φₙ represents a wind velocity in the n-th observation target.

However, the estimated value of the meteorological parameter calculated in the above manner includes an influence that each observation target receives from other observation targets.

The error influence degree calculator 105 calculates an estimated error contained in the meteorological parameter output by the meteorological parameter calculator 104. The estimated error is the difference between the true value of the meteorological parameter and the estimated value and is an error based on an influence from the other observation targets. Specifically, the error influence degree calculator 105 calculates the estimated error using the estimated error calculating expression, which is determined for each kind of the meteorological parameter, based on the estimated value of the meteorological parameter, the weight vector, and the waveform information matrix.

For example, in the case where the meteorological parameter represents signal power, the error influence degree calculator 105 can calculate an estimated error of a signal power using the following estimated error calculating expression.

$$\begin{matrix}[ Expression 6 ] & \\ {σ}_{pj} = {\sum }_{n = 1}^{N} {E}_{jn} {\hat{P}}_{n} ( n \neq j ) & ( 6 )\end{matrix}$$

A sign “σₚⱼ” represents an estimated error occurring in an estimated value “hat Pⱼ” of the signal power of the j-th observation target due to an influence that the j-th observation target receives from the other observation targets. The other parameters such as the “hat Pₙ” are the same as those in Expression (3).

Alternatively, for example, in the case where the meteorological parameter represents Doppler velocity, the error influence degree calculator 105 can calculate an estimated error of a Doppler velocity using the following estimated error calculating expression.

$$\begin{matrix}[ Expression 7 ] & \\ {σ}_{vj} = - \frac{λ}{4 π {T}_{s}} atan \frac{{\sum }_{n = 1}^{N} {E}_{jn} {\hat{P}}_{n} sin {\hat{φ}}_{n}}{{\sum }_{n = 1}^{N} {E}_{jn} {\hat{P}}_{n} cos {\hat{φ}}_{n}} ( n \neq j ) & ( 7 )\end{matrix}$$

A sign “σᵥⱼ” represents an estimated error occurring in the estimated value of the Doppler velocity due to an influence that the j-th observation target receives from the other observation targets.

As with these meteorological parameters, the error influence degree calculator 105 selects an estimated error calculating expression to be used based on the kind of the meteorological parameter and substitutes the value of the meteorological parameter calculated by the meteorological parameter calculator 104 into the estimated error calculating expression. In such a manner, the estimated error can be calculated.

Furthermore, the error influence degree calculator 105 calculates an error influence degree based on the calculated estimated error for each observation target. The error influence degree is a guide for selecting an observation target serving as a base when the error reducer 106 reduces the estimated error. A method for calculating the error influence degree may be freely determined. For example, the error influence degree may be the estimated error itself. Alternatively, in order to reduce the influence of the magnitude of the estimated value, the error influence degree may be a value that is the estimated error divided by the estimated value of the meteorological parameter on an observation target in question. For example, in the case of signal power, the error influence degree for the j-th target is “σₚⱼ/hat Pⱼ”.

Based on the error influence degree, an observation target (first observation target) is selected. A condition for selecting the observation target may be freely determined. For example, the condition may be determined with the accuracy of a final processing result, the load of the processing, or the like taken into account. For example, it is conceivable to select an observation target having a smallest error influence degree.

The error reducer 106 subtracts, from an estimated value of the meteorological parameter on an observation target (second observation target) other than the selected observation target (first observation target), an estimated error that the first observation target gives to the second observation target. The subtraction is performed on individual observation targets other than the first observation target. This reduces influences given to estimated values of the meteorological parameters on the other observation targets by the selected observation target, which brings the estimated values close to their respective true values.

Note that the error reducer 106 may acquire an estimated error that the selected observation target gives to the other observation target from the error influence degree calculator 105, or may newly calculate the estimated error.

The error reducer 106 delivers the estimated values of the meteorological parameters on the individual observation targets calculated by the subtraction to the meteorological parameter calculator 104. Alternatively, the error reducer 106 outputs the estimated values via an output device (not illustrated). The meteorological parameter calculator 104 substitutes the delivered estimated values of the meteorological parameters, as true provisional values, into a calculating expression such as Expression (3) to calculate new estimated values of the meteorological parameters. Then, the new estimated values of the meteorological parameters are delivered to the error influence degree calculator 105. This causes the process by the error influence degree calculator 105 and the process by the error reducer 106 to be performed based on the new estimated values of the meteorological parameters. In the processes for the second or subsequent times, the error influence degree calculator 105 selects an observation target from among observation targets excluding ones once selected. The repetition of these processes reduces estimated errors given by the individual observation targets, which allows data with reduced estimated errors to be acquired.

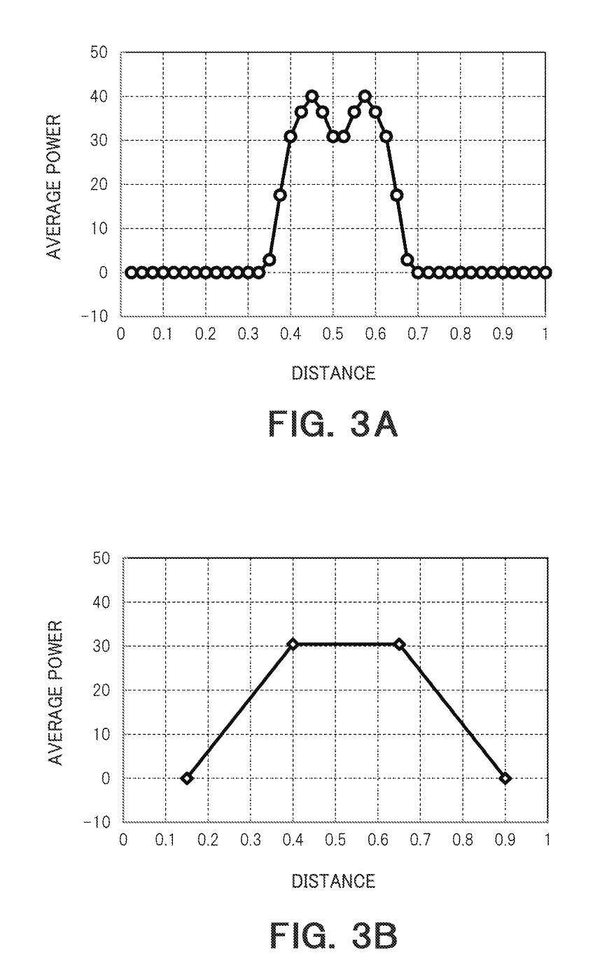

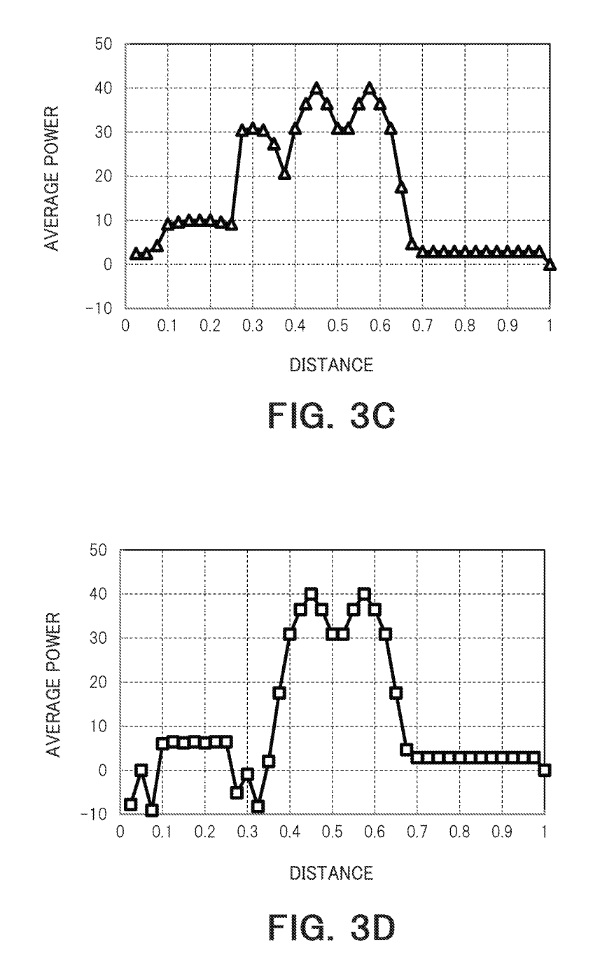

FIG. 3A to FIG. 3D are diagrams for illustrating the performance of the present embodiment. FIG. 3A illustrates a true signal power of an observation target. FIG. 3B illustrates a signal power obtained when not performing the oversampling. FIG. 3C illustrates a signal power obtained when performing only the oversampling. FIG. 3D illustrates an estimated value (signal power) calculated by the present embodiment. The horizontal axis of each drawing represents relative range normalized by a maximum distance, and the vertical axis represents an average power.

In FIG. 3, it is assumed that a transmission pulse is an ideal rectangular wave, a received signal is received through an ideal receiving filter, and a weight vector to be multiplied to the received signal is calculated by the Capon method. A correlation matrix to be used to calculate a weight vector is calculated from the number of ideal snapshots. In addition, the oversampling coefficient “L” is assumed to be 10.

FIG. 3A illustrates two peaks between a range of 0.4 and a range of 0.6. As illustrated in FIG. 3B, when the oversampling is not performed, the two peaks cannot be distinguished from each other. In FIG. 3C, although the two peaks can be distinguished from each other, a peak not being present at the true signal powers in FIG. 3A is present in the vicinity of a range of 0.3. Thus, in the case of performing only the oversampling, an estimated error such as one in the vicinity of the range of 0.3 in FIG. 3C occurs. In contrast, in FIG. 3D, two peaks are present between the ranges of 0.4 and the ranges of 0.6, and no peak is present in the vicinity of the range of 0.3. Consequently, it is found that the first embodiment has an enhanced resolution and allows data having a reduced influence of an estimated error to be acquired.

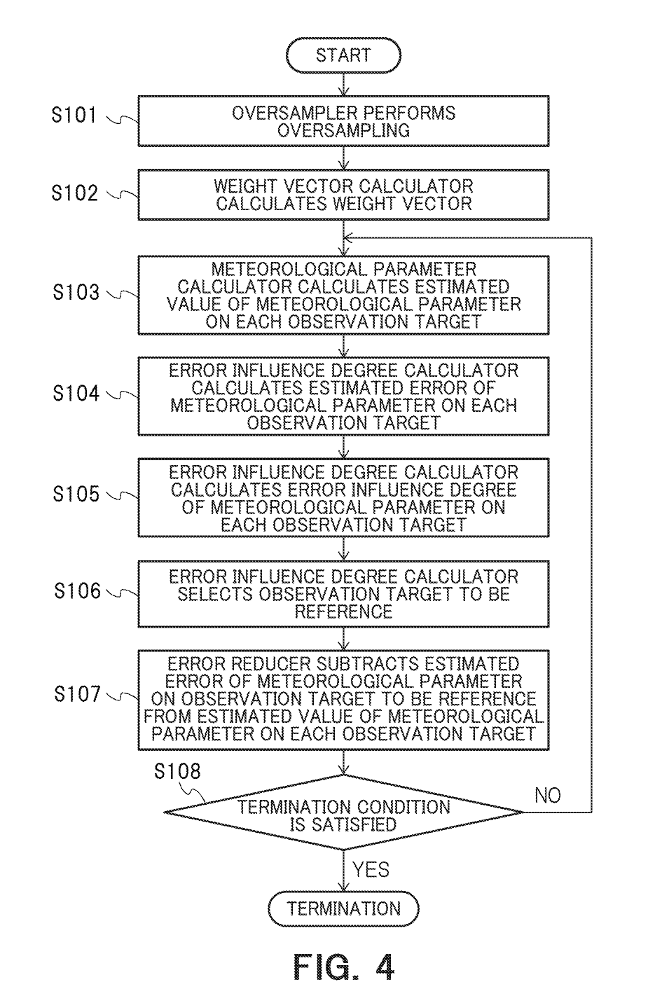

Next, a flow of processing performed by the radar apparatus according to the present embodiment will be described. FIG. 4 is a flowchart of processing performed on a received signal performed by the radar apparatus according to the present embodiment. This flow may be started at any timing, and may be started with a timing at which the oversampler 102 acquired a received signal or may be automatically started at a predetermined timing.

The oversampler 102 performs oversampling on an acquired received signal (S101). It is assumed that information necessary for the oversampling, for example, a pulse width “t”, the range width of an observation target, an oversampling coefficient “L”, or the like, is acquired or calculated in advance. A sampling signal vector “V” acquired through the oversampling is transmitted to the weight vector calculator 103.

Based on the transmitted sampling signal vector “V” and a waveform information matrix “Q”, the weight vector calculator 103 calculates a weight vector “Q” using a predetermined calculating expression (S102). The waveform information matrix “Q” may be determined in the weight vector calculator 103 in advance, may be acquired from the oversampler 102, or may be calculated by the weight vector calculator 103. The weight vector “Ω”, the sampling signal V, and the waveform information matrix “Q” are transmitted to the meteorological parameter calculator 104. In addition, the weight vector “Ω” and the waveform information matrix “Q” are also transmitted to the error influence degree calculator 105.

Based on the transmitted weight vector “Ω” and waveform information matrix “Q”, the meteorological parameter calculator 104 calculates a predetermined meteorological parameter using a predetermined calculating expression (S103). Additional information necessary for the calculation of the meteorological parameter may be determined in the meteorological parameter calculator 104 in advance or may be acquired from the weight vector calculator 103 or the oversampler 102. Examples of the additional information include the initial value of an estimated value, the wavelength “λ” of a transmission pulse, the pulse repetition interval “T_{S}”, the correlation coefficient “Rₜⱼ”, and the like. An estimated value of the calculated meteorological parameter is transmitted to the error influence degree calculator 105.

With a predetermined calculating expression, the error influence degree calculator 105 calculates an estimated error based on the estimated value of the meteorological parameter, the weight vector “Ω”, and the waveform information matrix “Q” (S104). Additional information necessary for the calculation of the estimated error may be determined in the error influence degree calculator 105 in advance or may be acquired from the meteorological parameter calculator 104 or another component.

In addition, the error influence degree calculator 105 calculates the error influence degree of a meteorological parameter on each observation target based on the estimated error of the meteorological parameter of the observation target (S105). Then, based on the error influence degree and a predetermined condition, the error influence degree calculator 105 selects an observation target to be a reference (S106). The calculated estimated error and information to distinguish the selected observation target are transmitted to the error reducer 106.

The error reducer 106 subtracts an estimated error given to each observation target by the selected observation target from an estimated value of meteorological parameter on the each observation target (S107). Then, the error reducer 106 checks for a termination condition, and if the termination condition is not satisfied (NO in S108), the error reducer 106 transmits the updated estimated value of the meteorological parameter to the meteorological parameter calculator 104. Then, the processes of S103 to S107 are repeated. If the termination condition is satisfied (YES in S108), this flow is terminated. Note that the error reducer 106 may output an estimated value of the updated meteorological parameter via an output device (not illustrated) or the like.

A termination condition of the repeated processes may be the number of repetitions of the processes of S103 to S107 or may be a value such as the amount of increase or decrease in the estimated error or the meteorological parameter.

Note that this flowchart is merely an example, and the flow of processing performed by the radar apparatus according to the present embodiment is not limited to this flowchart as long as the flow allows for the calculation of the update meteorological parameter. For example, the observation target to be a reference does not have to be selected by the error influence degree calculator 105 and may be selected by the error reducer 106. In addition, for example, the determination as to whether or not the termination condition is satisfied does not have to be performed by the error reducer 106 and may be performed by the meteorological parameter calculator 104.

As described above, according to the present embodiment, by performing the temporal oversampling, it is possible to enhance the resolution in the range direction and to calculate a meteorological parameter having a small estimated error through the reduction of an estimated error included in an estimated value.

### Second Embodiment

In the first embodiment, in order to enhance the range resolution, the temporal oversampling is performed. In a second embodiment, spatial oversampling is performed to enhance a resolution in a spatial direction, namely, the cell resolution.

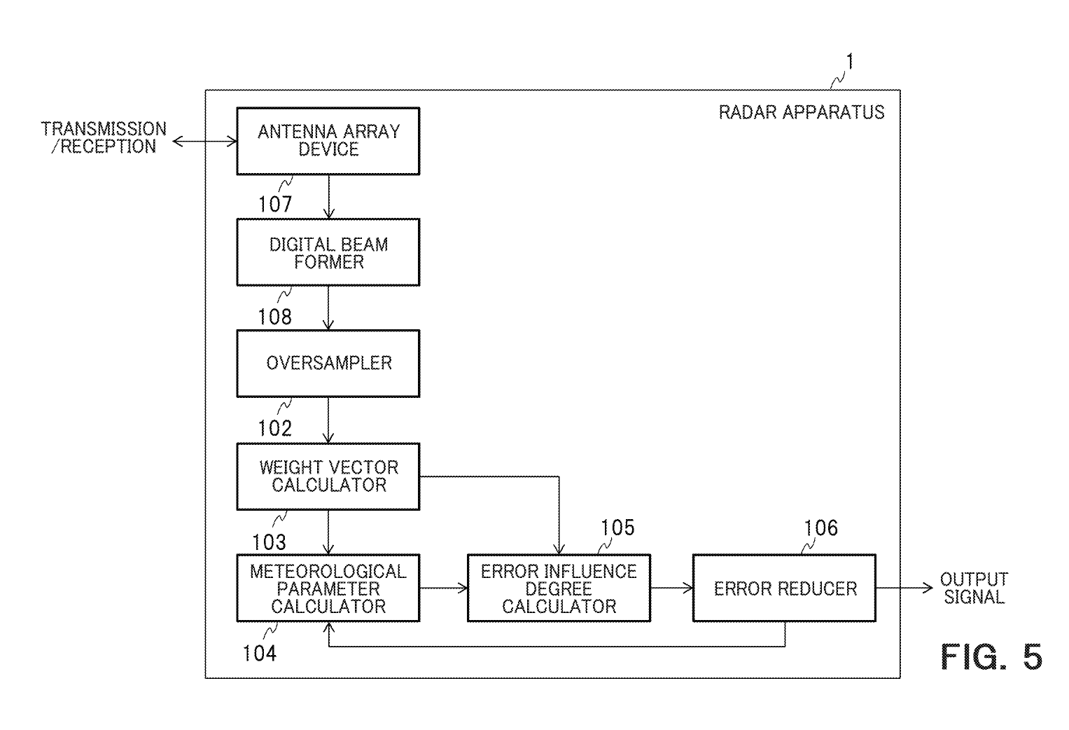

FIG. 5 is a block diagram illustrating an example of a schematic configuration of a radar device according to the second embodiment.

A radar apparatus 1 according to the present embodiment differs from the radar apparatus 1 in the first embodiment in that the antenna device 101 is replaced with an antenna array device 107, and a digital beam former (DBF) 108 is further included. The same components and processes as those in the first embodiment will not be described.

The antenna array device 107 is an antenna including a plurality of antenna elements, and transmits and receives beams. Examples of the antenna array device include a phased-array antenna device and the like.

The digital beam former 108 performs digital beamforming on a signal received by the antenna array device 107. The digital beamforming means the formation of a plurality of antenna beams by performing digital processing on signals received by the antenna elements. Thereby, a plurality of beams (a multibeam) are formed, the multibeam having a beam width smaller than that of the transmitted beams.

The oversampler 102 performs the spatial oversampling on the multibeam generated through the digital beamforming.

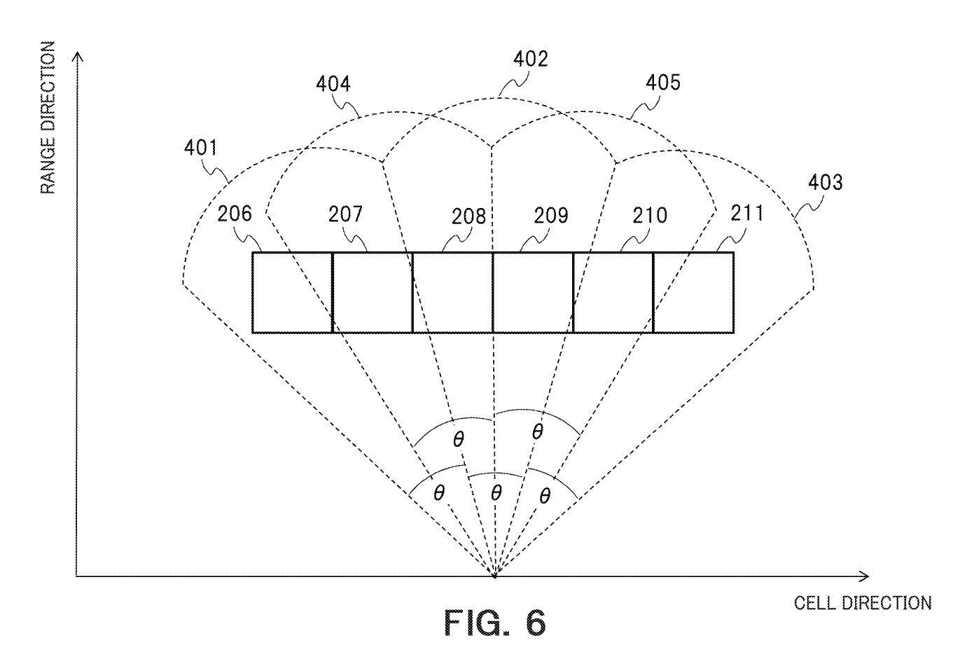

FIG. 6 is a diagram for illustrating the spatial oversampling. In FIG. 6, the vertical axis represents the range direction, and the horizontal axis represents the cell direction. FIG. 6 is a plan view when observation targets are seen from above. Rectangles illustrated in FIG. 6 are observation targets 206 to 211. The observation targets are assumed to be distributed in the cell direction. In addition, fan-shaped zones illustrated by dotted lines in FIG. 6 are formed beams 401 to 405. The angle of each beam is denoted by θ.

The digital beam former 108 forms the multibeam so that the beams do not overlap one another. In the example illustrated in FIG. 6, the beams 401 to 403 are formed. The formed beams are assumed to have about two the width of observation targets, as illustrated in FIG. 6. The resolution of sampling performed by the digital beam former 108 is twice lower than the desired resolution. Therefore, this configuration as it is cannot allow an accurate observation of observation targets.

Meanwhile, the oversampler 102 forms beams that overlap partly one another. In the example illustrated in FIG. 6, the beams 404 and 405 are further formed. This yields a resolution twice higher than that in not performing the oversampling. In such a manner, performing the spatial oversampling enhances a resolution.

The position or amount of overlapping the beams is set using the oversampling coefficient “L” as in the first embodiment. Letting r denote the distance from the radar apparatus 1 to an observation target, since the angle of a beam (beam width) is θ, a width Δ of the resolution in the cell direction is determined as Δ=θr at a location where an observation target is present. Therefore, for example, when the width in the cell direction specified by a user or another apparatus is half the width Δ of the resolution in the cell direction, as illustrated in FIG. 6, the oversampling coefficient “L” is determined as L=2. Therefore, in the case of FIG. 6, the beam 404 is positioned at the midpoint between the beams 401 and 402, and the beam 405 is positioned at the midpoint between the beams 402 and 403.

The oversampler 102 performs the oversampling to acquire a sampling signal, as described the above. The weight vector calculator 103 calculates the weight vector Ω as in the first embodiment, but the waveform information matrix Q used in the calculation is not based on the waveform of the transmission pulse but on the waveform of the transmission beam. The waveform of the transmission beam may be acquired from the antenna array device 107 or may be determined in advance.

The processes performed by the components and the flow in the present embodiment are the same as those in the first embodiment and thus will not be described. Since the processes are performed as in the first embodiment, the present embodiment has a higher resolution than that in the case of not performing the oversampling as in the first embodiment, and influence of estimated error in an estimated value calculated by the present embodiment is reduced.

As described above, according to the present embodiment, by performing the spatial oversampling, it is possible to enhance the resolution in the cell direction and to calculate a meteorological parameter having a reduced estimated error through the reduction of an estimated error included in an estimated value.

Although it is assumed in the embodiments described thus far that the radar apparatus transmits a beam and receives a reflected wave, the radar apparatus may be a received signal processing apparatus including the components processing a received signal in the embodiments described thus far, namely, the oversampler 102 to the error reducer 106. In embodiments according to received signal processing apparatus, it is assumed that an external apparatus transmits a beam, receives a reflected wave, and extracts a received signal, and the received signal processing apparatus handles the received signal.

Moreover, each process in the embodiments described above can be implemented by software (program). Thus, the radar apparatus and the received signal processing apparatus according to the embodiments described above can be implemented using, for example, a general-purpose computer apparatus as basic hardware and causing a processor mounted in the computer apparatus to execute the program.

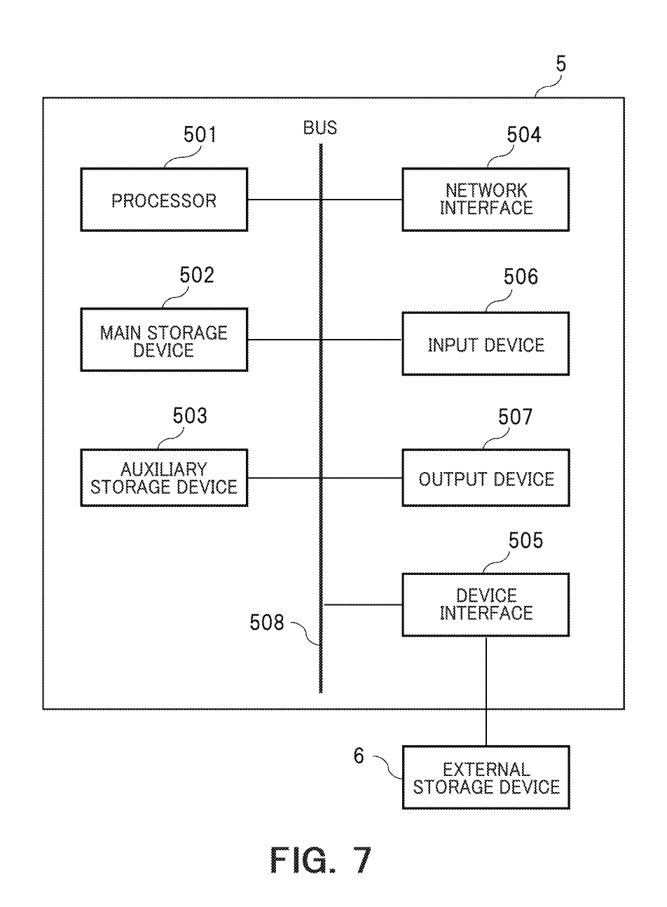

FIG. 7 is a block diagram illustrating an example of a hardware configuration in an embodiment of the present invention. The radar apparatus can be implemented as a computer apparatus 5 that includes a processor 501, a main storage device 502, an auxiliary storage device 503, a network interface 504, a device interface 505, an input device 506, and an output device 507, which are connected to one another through a bus 508.

The processor 501 reads a program from the auxiliary storage device 503, expands the program on the main storage device 502, and executes the program, thereby implementing the functions of the oversampler 102, the weight vector calculator 103, the meteorological parameter calculator 104, the error influence degree calculator 105, the error reducer 106, and the digital beam former 108.

The processor 501 is an electronic circuit including a control device and an arithmetic device for the computer. The processor 501 may be, for example, a general-purpose processor, a central processing unit (CPU), a microprocessor, a digital signal processor (DSP), a controller, a microcontroller, a state machine, an application-specific integrated circuit (ASIC), a field programmable gate array (FPGA), a programmable logic device (PLD), or a combination thereof.

A radar apparatus and a received signal processing apparatus in the present embodiment may be implemented by installing programs to be executed by the individual apparatus on the computer apparatus in advance, or by storing the programs in a storage medium such as a CD-ROM or distributing the programs over a network, and installing the programs on the computer apparatus appropriately.

The main storage device 502 is a memory device in which commands to be executed by the processor 501, various kinds of data, and the like are temporarily stored, and may be a volatile memory such as a DRAM or may be a nonvolatile memory such as an MRAM. The auxiliary storage device 503 is a storage in which the programs, the data, and the like are permanently stored, and one such example is a flash memory.

The network interface 504 is an interface for connecting with a communication network in a wireless or wired manner. Through the network interface 504, an output result or the like may be transmitted to another communicating apparatus. Although only one network interface 504 is illustrated, a plurality of network interface 504 may be mounted.

The device interface 505 is an interface such as a USB for connecting with an external storage medium 6 that records an output result or the like. The external storage medium 6 may be any storage medium such as an HDD, CD-R, CD-RW, DVD-RAM, DVD-R, and storage area network (SAN). In addition, through the device interface 505, an external apparatus (not illustrated) or the like may be connected with.

The input device 506 is a device that allows information to be input into the computer. Examples of the input device 506 include a keyboard, mouse, and the like, but are not limited to these. By using the input device 506, a user is allowed to input a window function to be used.

The output device 507 is a device that outputs an output result. For example, the output device 507 may be a display device for displaying an image, or may be a device for outputting a sound. Examples of the output device 507 include a LCD (liquid crystal display), a CRT (cathode-ray tube), a PDP (plasma display panel), a speaker, and the like, but are not limited to these. An output signal from an output signal creator 35 or the like can be checked using the output device 507.

The main storage device 502 is a memory device in which commands to be executed by the processor 501, various kinds of data, and the like are temporarily stored, and may be a volatile memory such as a DRAM or may be a nonvolatile memory such as an MRAM. The auxiliary storage device 503 is a storage in which the programs, the data, and the like are permanently stored, and one such example is an HDD or SSD.

The components processing a signal in the radar apparatus may be configured by dedicated hardware such as a semiconductor integrated circuit implementing the processor 501.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A radar apparatus comprising:
an oversampler configured to acquire a sampling signal by performing oversampling on a received signal;
a weight vector calculator configured to calculate a weight vector based on the sampling signal and a waveform information matrix;
a meteorological parameter calculator configured to calculate an estimated value of a meteorological parameter on an observation target based on the weight vector and the waveform information matrix;
an error influence degree calculator configured to select a first observation target considering an estimated error included in the estimated value of the meteorological parameter, or an error influence degree based on the estimated error; and
an error reducer configured to subtract an estimated error that the first observation target gives to an estimated value of a meteorological parameter on a second observation target, from the estimated value of the meteorological parameter on the second observation target.

2. The radar apparatus according to claim 1, wherein the oversampler performs temporal oversampling in which sampling is performed with a sampling time shorter than a pulse width of a transmission signal that is an origin of the received signal.

3. The radar apparatus according to claim 2, wherein the oversampler determines the sampling time based on the pulse width of the transmission signal, and an oversampling coefficient or a specified width in a range direction.

4. The radar apparatus according to claim 1, further comprising:
an antenna array device including a plurality of antenna elements; and
a digital beam former configured to perform digital beamforming on signals received by the plurality of antenna elements of the antenna array device, wherein
the oversampler forms a beam that overlaps the beams formed by the digital beam former so as to perform spatial oversampling.

5. The radar apparatus according to claim 4, wherein the oversampler determines a position of the beam to be formed based on a distance up to the observation target in a range direction, a beam width of the beams formed by the digital beam former, and an oversampling coefficient or a specified width in a cell direction.

6. The radar apparatus according to claim 1, wherein the first observation target is an observation target that is smallest in the estimated error or lowest in the error influence degree.

7. The radar apparatus according to claim 1, wherein the weight vector calculator calculates the weight vector based on a Capon method, a Fourier method, or a minimum mean square error (MMSE) method.

8. The radar apparatus according to claim 1, wherein the meteorological parameter represents signal power or Doppler velocity.

9. An observing method for causing performed by a computer, the method comprising:
acquiring a sampling signal by performing oversampling on a received signal;
calculating a weight vector based on the sampling signal and a waveform information matrix;
calculating an estimated value of a meteorological parameter on an observation target based on the weight vector and the waveform information matrix;
selecting a first observation target considering an estimated error included in the estimated value of the meteorological parameter, or an error influence degree based on the estimated error; and
an error reducing step of subtracting an estimated error that the first observation target gives to an estimated value of a meteorological parameter on a second observation target, from the estimated value of the meteorological parameter on the second observation target.

10. A non-transitory computer readable medium having a program stored therein which causes a computer when executed by the computer, to perform processes comprising:
acquiring a sampling signal by performing oversampling on a received signal;
calculating a weight vector based on the sampling signal and a waveform information matrix;
calculating an estimated value of a meteorological parameter on an observation target based on the weight vector and the waveform information matrix;
selecting a first observation target considering an estimated error included in the estimated value of the meteorological parameter, or an error influence degree based on the estimated error; and
an error reducing step of subtracting an estimated error that the first observation target gives to an estimated value of a meteorological parameter on a second observation target, from the estimated value of the meteorological parameter on the second observation target.
